(19) United States
(12) Patent Application Publication
(10) Pub. No.: US 2010/0277160 A1
(43) Pub. Date: Nov. 4, 2010

(54) MAGNETIC SENSOR DEVICE

(75) Inventors: Femke Karina De Theije, Berghem (NL); Jeroen Hans Nieuwenhuis, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/747,527

(22) PCT Filed: Dec. 12, 2008
(86) PCT No.: PCT/IB08/55236

§ 371 Date: Jun. 11, 2010

(30) Foreign Application Priority Data
Dec. 18, 2007 (EP) 07123465.2

(51) Int. Cl. G01N 27/74

(52) U.S. Cl. 324/204

(57) ABSTRACT

A magnetic sensor device (20) for determining the presence and/or amount of target moieties in a sample fluid is provided. The magnetic sensor device comprises:—a sensor chamber (12) having a sensor surface (120), the sensor surface comprising a plurality of binding sites (121) adapted for binding magnetic or magnetizable objects; and—a magnetic field generating means (26) adapted for generating a magnetic field for inducing a movement of magnetic or magnetizable objects along the sensor surface (120), the magnetic fields having a magnetic field gradient across the sensor surface (120). The magnetic field gradient generated by the magnetic field generating means (26) in each of the centres of the plurality of binding sites (121) is substantially identical.

The present invention relates to a magnetic sensor device and to a method for determining the presence and/or amount of target moieties in a sample fluid as well as a method making such as sensor.

Magnetic sensors based on AMR (anisotropic magneto resistance), GMR (giant magneto resistance) and TMR (tunnel magneto resistance) elements or on Hall sensors, are nowadays gaining importance. Besides the known high-speed applications such as magnetic hard disk heads and MRAM, new relatively low bandwidth applications appear in the field of molecular diagnostics (MDx), etc.

The introduction of micro-arrays or biochips comprising such magnetic sensors is revolutionising the analysis of biomolecules such as DNA (desoxyribonucleic acid), RNA (ribonucleic acid) and proteins. Applications are, for example, human genotyping (e.g. in hospitals or by individual doctors or nurses), bacteriological screening, biological and pharmacological research. Such magnetic biochips have promising properties for, for example, biological or chemical sample analysis, in terms of sensitivity, specificity, integration, ease of use and costs.

Biochips, also called biosensor chips, biological microchips, gene-chips or DNA chips, consist in their simplest form of a substrate on which a large number of different probe molecules are attached, on well-defined regions on the chip (binding sites of the sensor surface), to which molecules or molecule fragments that are to be analysed can bind if they are perfectly matched. For example, a fragment of a DNA molecule binds to one unique complementary DNA (c-DNA) molecular fragment. The occurrence of a binding reaction can be detected, for example by using markers, e.g. fluorescent markers or magnetic labels, which are coupled to the molecules to be analysed, either before or after binding of these molecules to the probe molecules. Coupling the molecules to magnetic labels is also referred to as labelling. Binding labelled molecules to probe molecules provides the ability to analyse small amounts of a large number of different molecules or molecular fragments in parallel, in a short time.

In a biosensor an assay takes place. During assays, some of the magnetic labels will bind with a molecule in the sample fluid and thereby form a labelled molecule. Other magnetic labels may not bind to a molecule. When the sample fluid, comprising labelled molecules, is provided to the sensor surface, the labelled molecules may bind to probe molecules present on the binding site or sites of sensor surface. The magnetic labels coupled to the molecules become so-called bound magnetic labels. Other magnetic labels, which are not bound to a molecule in the sample fluid, remain non-bound magnetic labels. Some of the non-bound magnetic labels may remain present at the binding site or sites of sensor surface. In case they are not removed, the detection of magnetic labels, in this situation bound and unbound, will cause the detection signal to be less or even not at all representative for the presence of molecules to be analysed. Hence, measures are to be taken to remove non-bound magnetic labels form the binding site or sites of sensor surface.

The forces acting upon the magnetic particles of magnetic or magnetizable objects are caused by applying a magnetic field by means of a magnetic field generating means, more particular by gradients in the magnetic field applied. At present, the geometry of the magnetic field generating means is typically a trade-off between homogeneity of the field gradient versus the magnitude of the magnetic forces that can be generated. For rapid bio sensors, typically magnetic field generating means are selected that are optimized with regard to the magnetic force and as a consequence the field gradients are not homogeneous over the sensor surface, in particular over the binding site or sites of the sensor surface. As a consequence the magnetic or magnetizable objects, e.g. magnetic particles, will experience a lateral force that will focus the magnetic or magnetizable objects on focussing points or regions at the binding site or sites of the sensor surface. At the focussing points or regions, the magnetic or magnetizable objects will have significantly more interaction with the binding site present at the sensor surface, which results in e.g. an inhomogeneous binding of labelled target moiety over the binding site of the sensor surface, in case the magnetic or magnetizable objects are used to label target moieties in sample fluid.

It is an object of the present invention to provide a magnetic sensor device. An advantage of the magnetic sensor device is that it allows assays to be performed rapidly. Another advantage is that the assay may be performed with a high sensitivity. Yet another advantage is that the assay may be performed with more a homogeneous distribution of the magnetic or magnetizable objects at the binding site of the sensor surface.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

According to a first aspect of the present invention, a magnetic sensor device is provided for determining the presence and/or amount of target moieties in a sample fluid. The magnetic sensor device comprises:
a sensor chamber having a sensor surface, the sensor surface comprising a plurality of binding sites adapted for binding magnetic or magnetizable objects;
a magnetic field generating means adapted for generating a magnetic field for inducing a movement of magnetic or magnetizable objects along the sensor surface, the magnetic field having a magnetic field gradient across the sensor surface;
   wherein the magnetic field gradient generated by the magnetic field generating means in each of the centres of the plurality of binding sites is substantially identical.

The magnetic field gradient is the variation in the magnetic field strength with respect to the position of the centre. More particularly, the variation of the magnetic field strength in the direction of movement of magnetic or magnetizable objects along the sensor surface is substantially identical for the centres of the binding sites. The term “substantially identical” is to be understood as deviating from the target value due to tolerances which can normally be expected in production processes of magnetic sensor devices.

The centre of a binding site is the geometrical centre of the surface of the binding site.

A magnetic sensor device according to embodiments of the first aspect of the present invention may have the advantage that the magnetic or magnetizable objects may be distributed more homogeneously over the sensor surface, allowing a more accurate detection and estimation of the amount of magnetic or magnetizable objects bound to the binding surfaces (also referred to as biospots). A magnetic sensor device according to embodiments of the first aspect of the present invention may provide a more homogeneous distribution of labels by designing the distribution of binding sites symmetrically with respect to the inhomogeneity of the magnetic field gradient.

The binding sites may optionally be distributed around the point where the magnetic field generating means generates its strongest magnetic field, having their respective centres located on a circle having the central point coinciding with the centre of the circle.

The binding sites may optionally be symmetrically distributed around the point or points where the magnetic field generating means generates its strongest magnetic field. A plurality, e.g. three, four, five, six, seven, eight or even more binding sites may be located with their respective centres on the corners of a regular polygon. A central point at the sensor surface, where the magnetic field generating means generates the strongest magnetic field may be located in the centre of this regular polygon.

For each binding site, magnetic or magnetizable objects may be provided in a first position, e.g. a position where a lower magnetic field strength is generated as compared to the field strength generated at the centre of the binding site. The magnetic field generating means is adapted to move, for each binding site, the respective magnetic or magnetizable objects to a second position, being a position where a higher magnetic field strength is generated by the magnetic field generating means. The magnetic field generating means move the magnetic or magnetizable objects from each of the respective first positions to the respective second positions. All second positions may coincide in a central point at the sensor surface, where the magnetic field generating means generates the strongest magnetic field.

Optionally, the magnetic field strength may be substantially identical in each of the centres of the binding sites. More particularly, the magnetic field strength in the direction of movement of the magnetic or magnetizable objects may be substantially identical in each of the centres of the binding sites.

Optionally, the magnetic field gradient over the surface of a binding site, i.e. in each point of the binding site, is substantially identical. Optionally, the magnetic field gradient over the surfaces of the binding sites, i.e. in each point of the binding sites, is substantially identical.

In some embodiments of the present invention, the strongest magnetic field generated by magnetic field generating means may occur at a central point of the sensor surface. The centres of the plurality of binding sites may be symmetrically distributed with regard to the central point.

In some embodiments of the present invention, the magnetic field generating means may be adapted for generating a magnetic field for moving magnetic or magnetizable objects not bound to the binding sites towards the central point.

The distance between the central point and each of the boundaries of the plurality of binding sites on the sensor surface is optionally larger than the distance of diffusion transport of magnetic or magnetizable objects in absence of magnetic field induced by the magnetic field generating means.

The magnetic field generating means may be adapted for generating a magnetic field for moving magnetic or magnetizable objects over a travel distance or moving distance larger than the width of the largest of the binding sites, the width being measured in travelling direction of the magnetic or magnetizable object in the centre of the binding site.

The binding sites may be provided with their centres such that in these centres, a substantially identical magnetic field gradient is generated. The binding sites may be provided with identical properties, e.g. having an identical contour and/or surface area and/or binding identical or different magnetic or magnetizable objects by means of similar or identical or different bonds.

The magnetic field generated by the magnetic field generating means causes the magnetic or magnetizable objects to move in a direction along the sensor surface, which movement may also be understood as magnetophoresis.

The binding sites of the sensor surface are adapted to bind magnetic or magnetizable objects. The binding may be obtained via target moieties in the sample fluid, or via a same or similar type of moiety, which compete with the target moieties in the sample fluid.

Labelled target moieties (also referred to as bound magnetic or magnetizable objects) are target moieties bound to a magnetic or magnetizable object.

The magnetic or magnetizable objects may first bind to the target moieties in the sample fluid, providing labelled target moieties. By applying a magnetic field for inducing a movement of magnetic or magnetizable objects along a binding site at the sensor surface, the labelled target moieties are moved along the sensor surface, where the target moieties, now being labelled, bind to the binding site, e.g. to target probes present on the binding site. As such, the magnetic or magnetizable objects, being part of labelled target moieties, are bound to binding sites they pass. The target moieties are used to bind the magnetic or magnetizable objects to the binding sites. Magnetic or magnetizable objects not bound to target moieties, i.e. not part of labelled target moieties, will not bind to a binding site on the sensor surface and may be moved to a position beyond the binding site.

Alternatively, the binding sites are provided with the same or a similar type of moieties, which compete with the target moieties in the sample fluid for binding to the magnetic or magnetizable objects. Magnetic or magnetizable objects may first bind to the target moieties in the sample fluid, providing labelled target moieties. By applying a magnetic field a movement of magnetic or magnetizable objects along a binding site of the sensor surface is induced. The labelled target moieties are moved along the binding site, where the target moieties are prevented from binding to the binding site since they are already bound to a magnetic or magnetizable object. The magnetic or magnetizable objects, not being bound to a target moiety, may bind to the binding site of the sensor surface via a bond between the magnetic or magnetizable object and the same or a similar type of moiety present on the binding site. The same or similar types of moiety present on the binding site are used to bind the magnetic or magnetizable objects to the binding site. Magnetic or magnetizable objects bound to target moieties, will not bind to the binding site on the sensor surface and may be moved to a position beyond the binding site.

In both situations, the detection of magnetic or magnetizable objects at the sensor surface will be indicative for the presence and optionally the amount of target moieties in the sample fluid, in case the reaction scheme of the assay is known.

The magnetic or magnetizable objects will be separated from each other such that only the magnetic or magnetizable objects bound to a binding site on the sensor surface remain present at the sensor surface.

Fluid wash steps, to cause the magnetic or magnetizable objects not bound to a binding site to be washed from the binding site, can be reduced in time or can even be avoided. Also the time necessary to have the magnetic or magnetizable objects flowing over the sensor surface may be reduced, as an active driving force for moving the magnetic or magnetizable objects over the sensor surface may be provided.

This makes devices according to embodiments of the present invention particularly fast.

As a result, assays may require less operational steps, hence become less complicated, and may be performed more rapidly and more sensitively. In some embodiments of the present invention, the magnetic sensor device may comprise a sensor substrate providing the sensor surface. The magnetic field generating means may be integrated in the sensor substrate.

As an example, the sensor device may be provided as an injection moulded device, e.g. an injection moulded piece of substrate, e.g. plastic material, e.g. transparent plastic. The detecting of magnetic or magnetizable objects may be done using an optical detection, detecting the presence and/or amount of target moieties on a sensor surface, which is visible for the optical detector through the injection, moulded substrate.

As another example, in case the sensor surface is provided as a part of a chip, the magnetic field generating means may be an on-chip magnetic field generating means.

In some embodiments of the present invention, the magnetic field generating means may be moveable relative to the sensor surface.

When the magnetic field generating means is to generate its magnetic field, the magnetic field generating means may be brought to a predefined position near the sensor surface.

In case the sensor surface is provided as a part of a chip, the magnetic field generating means may be an off-chip magnetic field generating means.

In some embodiments of the present invention, the magnetic field generating means may comprise at least one of a permanent magnet, a coil, a wire or an electromagnet.

The magnetic field generating means, optionally comprising a plurality of cooperating components, may be located under the channel surface of which the binding sites are part.

The magnetic field is generated by at least one field generating means, e.g. a permanent magnet, electromagnet, coils and/or wires. The strength of the magnetic force on the magnetic or magnetizable objects may be such that the induced travel distance is larger then the distance traveled without magnetic fields. The magnetic forces are dominant over translational Brownian motion.

A magnetic field generating means comprising components below the sensor surface may be used, which magnetic field generating means generates an essentially out-of-plane field with a smaller in-plane field. The in-plane field is to be sufficient for inducing a movement of the magnetic or magnetizable objects along the binding sites.

An in-plane field is to be understood as a magnetic field having field lines parallel to the sensor surface.

In some embodiments of the present invention, the magnetic sensor device further may comprise at least one detector for providing a detection signal representative for the presence and/or amount of magnetic or magnetizable objects bound to the binding sites.

In some embodiments of the present invention, the at least one detector may be a GMR element.

In some embodiments of the present invention, the at least one detector may be an optical detector.

Detection of the presence of labelled target moieties on the binding sites of the sensor surface can be done by various detection mechanisms, e.g. magnetically (e.g. magnetic sensors based on AMR (anisotropic magneto resistance), GMR (giant magneto resistance) and TMR (tunnel magneto resistance) elements or on Hall sensors), optically (reflection, absorption, scattering, fluorescence, chemiluminescence, RAMAN, etc.), acoustically (QCM, SAW, BAW, etc.), or electrically (impedance, conductance, electrochemically, redox recycling, etc.). The detectors may be integrated into the magnetic sensor device as a disposable part (e.g. magnetoresisitve sensor) or may be separated from the magnetic sensor device, optionally also as a disposable part (e.g. optical unit).

Each of the binding sites may co-operate with one detector, or one detector may be provided to detect presence of magnetic or magnetizable objects at each of the binding sites. It is understood also other combinations of a plurality of detectors, each co-operating with one or some of the binding sites may be provided.

The magnetic sensor device may be suitable for sensor multiplexing, e.g. due to the provision of a plurality of binding sites which bind to different target moieties of magnetic or magnetizable objects, e.g. by means of different target probes, provided on the sensor channel. The magnetic field generating means in such devices is adapted for generating a magnetic field for inducing a movement of the magnetic or magnetizable objects along the plurality of sensor surfaces.

The magnetic sensor device may be suitable for magnetic or magnetizable object multiplexing (use of different types of magnetic or magnetizable objects, e.g. with different magnetic and/or optical properties).

The pattern according to which the binding sites are located relative to the magnetic field generated according to embodiments of the present invention, helps to prevent cross-reactivity problems, since the magnetic or magnetizable objects, e.g. magnetic particles, of a specific kind only may get into contact with one specific binding site.

In some embodiments of the present invention, an actuator may be provided for activation and/or deactivation of the magnetic field generating means.

In some embodiments of the present invention, the magnetic sensor device further may comprise a control unit for controlling the actuator.

In some embodiments of the present invention, the magnetic sensor device may be a biosensor.

The magnetic sensor device may be used as a rapid, robust, and easy to use point-of-care biosensor for small sample volumes. The sensor channel may be part of a disposable device to be used with a compact reader, containing the magnetic field generating means and the detector.

The magnetic sensor device may be used for sensing small molecules, with a single epitope.

Alternatively the magnetic sensor device may be used in automated high-throughput equipment for centralized laboratories. In this case, the sensor channel may be part of e.g. a well plate or cuvette, fitting into an automated instrument.

Advantages of magnetic sensor devices according to embodiments of the present invention are the minimum number of fluid manipulation steps, high-speed incubation and wash, and minimal fluid waste.

In some embodiments of the present invention, the sensor chamber may comprise a plurality of magnetic or magnetizable objects storage sites for storing magnetic or magnetizable objects. The magnetic field generating means may be adapted for generating a magnetic field for inducing a movement of magnetic or magnetizable objects from one of the magnetic or magnetizable objects storage sites along one of the binding sites of the sensor surface.

In some embodiments of the present invention, for each of the binding sites, the sensor chamber may be provided with one dedicated magnetic or magnetizable objects storage site for storing magnetic or magnetizable objects for co-operating with the binding site. The magnetic field generating means may be adapted for generating a magnetic field for inducing a movement of the magnetic or magnetizable objects from the dedicated magnetic or magnetizable objects storage sites along the binding site. The binding site and the magnetic or magnetizable objects storing sites are to co-operate in a one-to-one relationship.

Each of the magnetic or magnetizable objects storage sites may be provided with a particular type of magnetic or magnetizable objects, suitable to co-operate with the binding site. The sensor chamber thus may comprise a plurality of different magnetic or magnetizable objects, each type of magnetic or magnetizable objects located on one of the magnetic or magnetizable objects storage sites.

The magnetic field generating means hence may move each of the different types of magnetic or magnetizable objects along a predefined, dedicated binding site. Cross-reactivity issues may as such be reduced or even avoided.

According to a second aspect of the present invention, the magnetic sensor device according to the first aspect of the present invention is used in molecular diagnostics, biological sample analysis or chemical sample analysis.

A magnetic sensor device according to embodiments of the present invention, being a biosensor, may be used for various different assays. Examples of assays are a sandwich assay (for large molecules, e.g. proteins, possessing at least two epitopes) or a competitive assay (small molecules that only possess one epitope). In a sandwich assay, molecules of interest from an applied sample fluid, i.e. target moieties, are trapped (sandwiched') between a biologically active sensor surface and biologically active labels, i.e. biologically active magnetic or magnetizable objects. In a competitive assay setup, target moieties from the sample compete with target molecules bound on the surface for binding to biologically active labels.

Target moieties may be large molecules (e.g. proteins, nucleic acids), small molecules (e.g. drugs, metabolites, peptides, sugars, hormones), cell fragments, etc.

According to a third aspect of the present invention, a magnetic sensor chip, optionally a biochip, is provided, the magnetic sensor chip comprising at least one magnetic sensor device according to the first aspect of the present invention.

According to a fourth aspect of the present invention, a method for determining the presence and/or amount of target moieties in a sample fluid is provided. The method is for use with a sensor surface having a plurality of binding sites adapted for binding magnetic or magnetizable objects, each binding site having a centre. The method comprises:
allowing target moieties in a sample fluid to bind with magnetic or magnetizable objects, thus providing labelled target moieties;
applying a magnetic field for inducing a movement of the magnetic or magnetizable objects along the binding sites, thus allowing magnetic or magnetizable objects to bind to the binding sites and moving magnetic or magnetizable objects not bound to a binding site to a position past the binding site, the magnetic field gradient generated in each of the centres of the plurality of binding sites being substantially identical;
obtaining a detection signal representative of presence of magnetic or magnetizable objects bound to the one or more binding sites, and
determining the presence and/or amount of target moieties in the sample fluid based upon the detected signal.

Optionally the method includes determination of the presence and/or amount of magnetic or magnetizable objects bound to the one of the binding sites of the sensor surface from the obtained detection signal.

In some embodiments of the present invention, the amplitude of the magnetic field is variable in time.

The amplitude of the magnetic field may be modulated for providing e.g. pulsed actuation.

In some embodiments of the present invention, allowing target moieties in the sample fluid to bind with magnetic or magnetizable objects may comprise providing a sample fluid with target moieties and providing magnetic or magnetisable objects to the sample fluid.

In some embodiments of the present invention, allowing target moieties in the sample fluid to bind with magnetic or magnetizable objects may comprise first providing the magnetic or magnetizable objects, prior to providing the sample fluid.

In some embodiments of the present invention, allowing target moieties in the sample fluid to bind with magnetic or magnetizable objects may comprise first providing the sample fluid prior to providing magnetic or magnetizable objects.

In some embodiments of the present invention, the labelled target moieties may be prevented from binding to at least one of the binding sites on the sensor surface.

The magnetic or magnetizable objects not bound to a target moiety may be bound to the binding sites present on the sensor surface. Optionally the same or a similar type of moieties, which compete with the target moieties in the sample fluid, are bound to one or more of the binding sites, e.g. to target probes present on the binding site. Magnetic or magnetizable objects not bound to target moieties, may bind to these same or similar types of moieties, which compete with the target moieties in the sample fluid. The magnetic or magnetizable objects, which are already bound to a target moiety, are prevented to bind to this same or a similar type of moieties, which compete with the target moieties in the sample fluid and are present on the binding sites.

In some embodiments of the present invention, the labelled target moieties may be bound to at least one of the binding sites on the sensor surface.

The magnetic or magnetizable objects bound to a target moiety may be bound to the binding sites present on the sensor surface. The binding sites are adapted to bind to the target moieties labelled by the magnetic or magnetizable objects, by means of target probes present on the binding site and suitable to bind with the target moiety. Magnetic or magnetizable objects not bound to target moieties have no such target moiety to establish a bound between binding site and magnetic or magnetizable object. The magnetic or magnetizable objects, which are not bound to a target moiety, are not bound to the binding sites.

Embodiments of the methods according to the fourth aspect of the present invention may be used in molecular diagnostics, biological sample analysis or chemical sample analysis.

According to a fifth aspect, the present invention provides a computer program product for performing, when executed on a processing system, a method according to the first aspect of the present invention.

The at least one magnetic sensor device may comprise at least one activatable magnetic field generating means. The activatable magnetic field generating means may be activated using an actuator, controlled by means of a control unit.

The control unit may further comprise a data capturing unit for obtaining a detection signal by means of at least one detector at least one of the binding sites of the sensor surface. The control unit may comprise a processing system adapted for determining the presence and/or amount of magnetic or magnetizable objects bound to one binding site on the sensor surface from the measured detection signal.

Knowing the reaction scheme of the assay, the control unit may use the detection signal, providing information on the presence and/or amount of magnetic or magnetizable objects bound to the a binding site of the sensor surface, to determine the presence and/or amount of the target moieties in the sample fluid. The amount of magnetic or magnetizable objects used in the assay may be taken into account.

The control unit thus may activate and/or deactivate the activatable magnetic field generating means by means of the one or more actuators. The control unit may obtain a detection signal and determine therefrom the presence and/or amount of target moieties according to predefined rules. The control unit may comprise a processing system, which may run a computer program product comprising instructions for executing a method for determining the presence and/or amount of target moieties in a sample fluid according to embodiments of the present invention.

Embodiments of the computer program product according to the fifth aspect of the present invention may be stored on a machine readable data storage device suitable to store the computer program product.

Embodiments of the computer program product according to the fifth aspect of the present invention may be transmitted over a local or wide area telecommunications network.

According to a sixth aspect of the present invention, a controller is provided for use in a method for determining the presence and/or amount of target moieties in a sample fluid and with a sensor surface having a plurality of binding sites adapted for binding magnetic or magnetizable objects, each binding site having a centre. The controller comprises:
means for controlling target moieties in a sample fluid to bind with magnetic or magnetizable objects, thus providing labelled target moieties;
means for controlling application of a magnetic field for inducing a movement of the magnetic or magnetizable objects along the binding sites, thus allowing magnetic or magnetizable objects to bind to the binding sites and moving magnetic or magnetizable objects not bound to a binding site to a position past the binding sites, the magnetic field gradient generated in each of the centres of the plurality of binding sites being substantially identical;
means for controlling generation of a detection signal representative of presence of magnetic or magnetizable objects bound to the one or more of the binding sites, and for determining the presence and/or amount of target moieties in the sample fluid based upon the detected signal.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

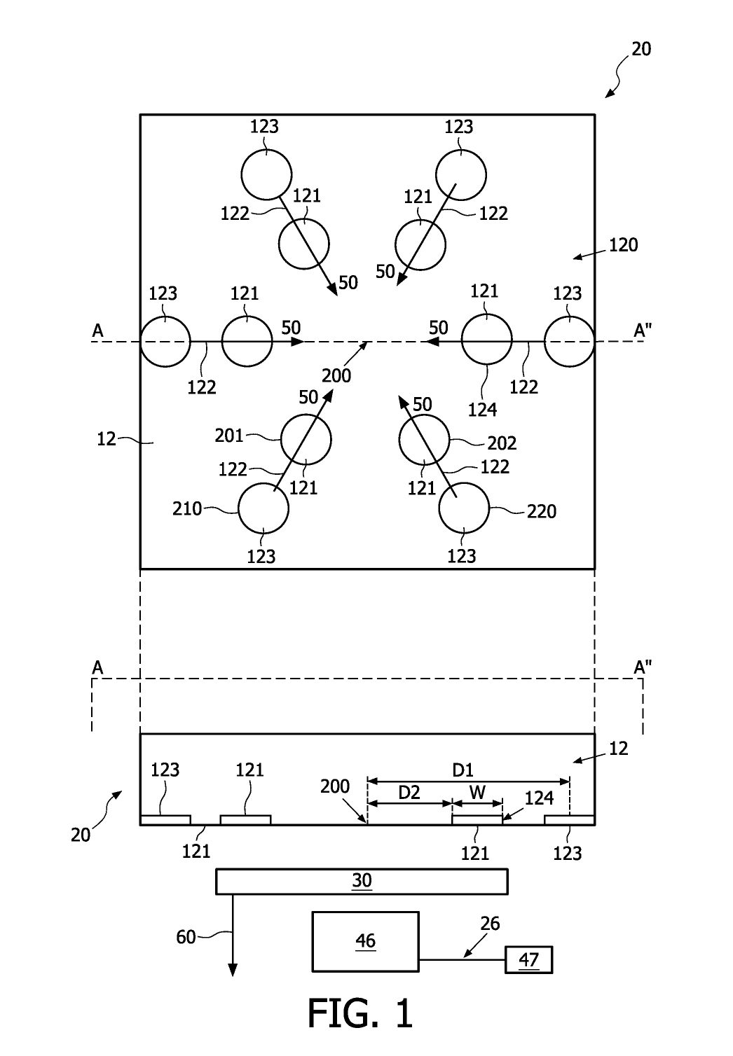

FIG. 1 shows schematically a top view and a longitudinal cross-section (according to plane AA') of an embodiment of a magnetic sensor device according to a first aspect of the present invention.

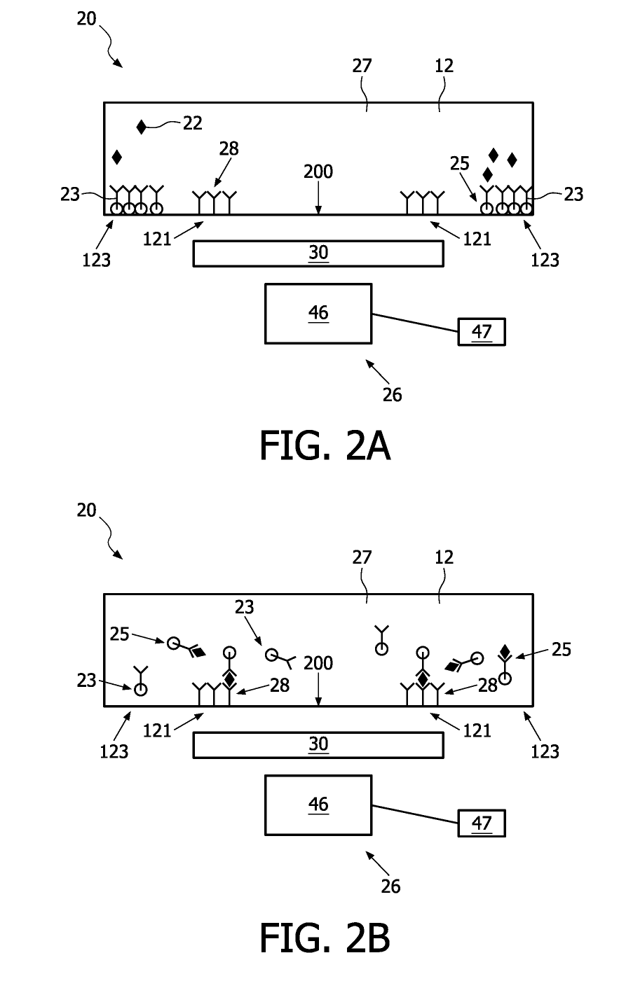

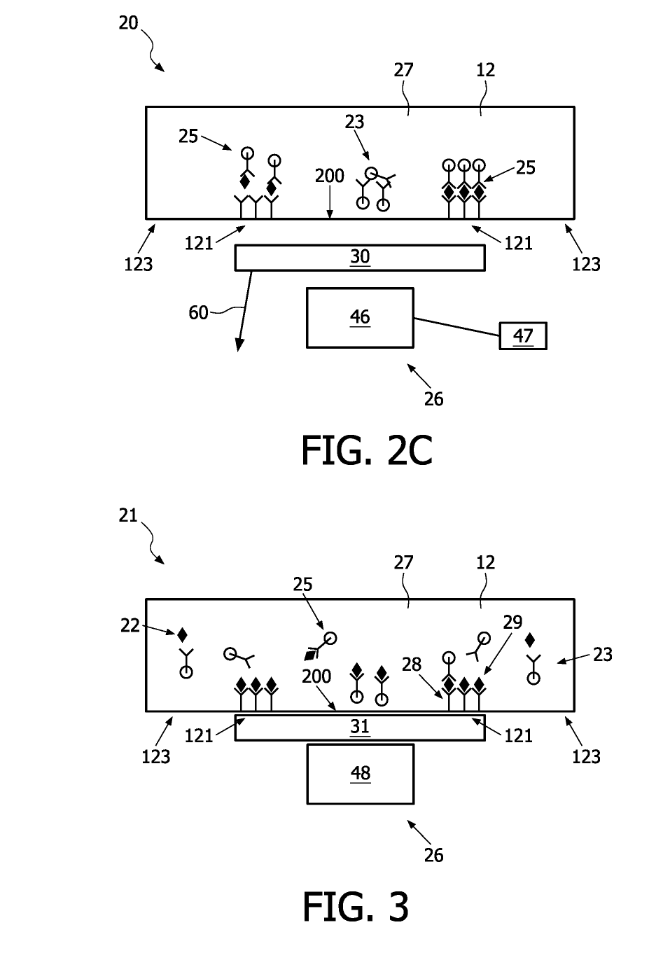

FIG. 2A, FIG. 2B and FIG. 2C, show schematically the magnetic sensor device of FIG. 1 at different moments in time during an assay.

FIG. 3 shows schematically a longitudinal cross-section of another embodiment of a magnetic sensor device according to a first aspect of the present invention.

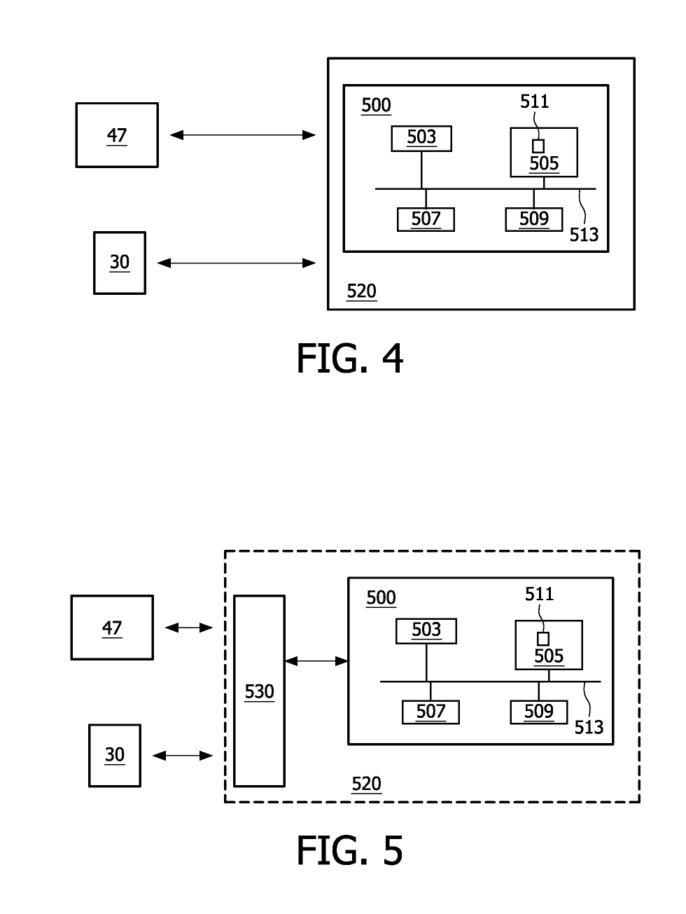

FIG. 4 and FIG. 5 show schematically a control unit comprising a processing system adapted for performing a method according to an embodiment of the present invention for determining the presence and/or amount of target moieties in a sample fluid.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

The present invention will be described by means of the magnetic or magnetizable objects being magnetic particles such as beads. This is only for the ease of explanation and is not intended to limit the invention in any way. The present invention also applies to a magnetizable object being a magnetic rod, a string of magnetic particles, or a composite particle, e.g. a particle containing magnetic as well as optically-active material, or magnetic material inside a non-magnetic matrix. In the following the term “magnetic particles” will be used and this is intended to include both magnetizable as well as (permanent) magnetic objects.

An embodiment of a magnetic sensor device 20 for determining the presence and/or amount of target moieties in a sample fluid according to a first aspect of the present invention is shown in FIG. 1. The magnetic sensor device 20 comprises:
a sensor chamber 12 having a sensor surface 120, the sensor surface 120 comprising a plurality of binding sites 121 adapted for binding magnetic or magnetizable objects;
a magnetic field generating means 26 adapted for generating a magnetic field for inducing a movement of magnetic or magnetizable objects along the sensor surface 120, the magnetic fields having a magnetic field gradient across the sensor surface 120.

The magnetic field gradient generated by the magnetic field generating means 26 in each of the centres 122 of the plurality of binding sites 121 is substantially identical. In this embodiment, the magnetic field strength generated by the magnetic field generating means 26 in each of the centres 122 of the plurality of binding sites 121 is substantially identical.

For each binding site 121 magnetic or magnetizable objects are provided in a first position 123, e.g. being a position where a lower magnetic field strength is generated as compared to the field strength generated at the centre 122 of the binding site. The magnetic field generating means 26 is adapted to move, for each binding site, the respective magnetic or magnetizable objects to a second position, being a position where a higher magnetic field strength is generated by the magnetic field generating means 26. In this embodiment, the magnetic field generating means 26 is adapted for generating a magnetic field for moving magnetic or magnetizable objects not bound to the binding sites to the central point 200, i.e. the point where the strongest magnetic field is generated by magnetic field generating means 26. The magnetic field generating means move the magnetic or magnetizable objects form each of the first positions 123 to the central point 200.

According to embodiments of the invention, the binding sites 121 of the magnetic sensor device 20 may be modified by a coating which is designed to attract certain target moieties or may be modified by attaching molecules, also referred to as target homologues or target probes, to it which are suitable to bind the target moieties which are possibly present in the sample fluid to be tested. In this way the binding sites 121 of the sensor surface 120 of the magnetic sensor device 20, are activated with such binding molecules to form specific binding points to enable restraint or immobilisation of target moieties. Such binding molecules are known to the skilled person and may include proteins, antibodies, nucleic acids (e.g. DNA, RNA), peptides, oligo- or polysaccharides or sugars, small molecules, hormones, drugs, metabolites, cells or cell fractions, tissue fractions, . . . . Such molecules may be attached to the sensor surface by means of spacer or linker molecules. Sensor surfaces can also be provided with molecules in the form of organisms (e.g. viruses or cells) or fractions of organisms (e.g. tissue fractions, cell fractions, membranes).

In this embodiment, the magnetic field generating means 26 is adapted for generating a magnetic field for moving of magnetic or magnetizable objects in a direction 50 along the sensor surface 120 towards the central point 200.

In this embodiment, an example of six binding sites 121 is shown which are symmetrically distributed around the central point 200, each of the binding sites 121 having its binding site centre 122 located on a corner of a regular hexagon. The shape according to which the binding sites are distributed, may resemble, i.e. be similar, even identical to the shape of the lateral gradient of the magnetic field. The lateral magnetic field gradient of the magnetic field generating means may typically be circular or elliptical shape. However, the present invention is not limited thereto. The centre of the hexagon coincides with the central point 200. For each of the binding sites 121, the magnetic field is adapted for moving of magnetic or magnetizable objects in a direction 50 along the sensor surface 120 from the binding site centre 122 towards the central point 200, i.e. in radial direction.

In this embodiment, the magnetic field generating means 26 is adapted for generating a magnetic field for moving of magnetic or magnetizable objects over a travel or moving distance D1 being larger than the width W of each of the binding sites 121 on the sensor surface 120. The width W may optionally be between 50 μm and 500 μm. Travel distance D1 may optionally be about 3 times as large as the width W, i.e. D1 ranging from 150 μm to 1500 μm.

In this embodiment, the magnetic field generating means 26 causes the magnetic or magnetizable objects to move, e.g. to roll, in a direction along the sensor surface 120, which movement may also be understood as magnetophoresis. When applying the magnetic field, by e.g. activating an activatable magnetic field generating means, such as by providing current to one or more electromagnets, the magnetic or magnetizable objects, whether they are labelled with target moieties or not, will move under the applied magnetic field towards the point of highest magnetic field strength, in this embodiment coinciding with the central point 200. Assuming the binding sites 121 are provided with target probes for binding to labelled target moieties, then when a labelled target moiety meets a target probe, the target moiety and the target probe may bind, thus preventing the magnetic or magnetizable object part of the labelled target moiety to continue to move further in the direction towards the central point 200.

Magnetic or magnetizable objects not bound to target moieties (also referred to as non-bound magnetic or magnetizable objects) are moved along the sensor surface 200 as well. As they do not bind to target probes of a binding site 121 on the sensor surface 200, their induced movement may proceed and bring them to a position, in this embodiment central point 200, beyond the binding site 121 in a direction 50.

As such, the bound and unbound magnetic or magnetizable objects will be separated from each other such that only the bound magnetic or magnetizable objects, being part of a plurality of labelled target moieties, remain present at the binding sites 121 of the sensor surface 120. This is obtained without an explicit washing step being necessary.

The distance D2 between the central point 200 and the boundary 124 of each of the binding sites 121 of the sensor surface 120 is optionally larger than the distance of diffusion transport of magnetic or magnetizable objects in absence of a magnetic field induced by the magnetic field generating means 26. As diffusion may be rather slow, the distance D2 may be kept quite small. However, since the lateral gradient typically may get less strong towards the centre 200, D2 may be a reasonably large distance, e.g. 200 μm.

The magnetic field generating means 26 may comprise a magnetic field generator or a magnetic field generating component, e.g. a permanent magnet or an electromagnet 46. The latter is more easily activated or deactivated using a control unit comprising an actuator 47.

For each binding site 121, magnetic or magnetizable objects are provided in a first position 123. The first position of the magnetic or magnetizable objects actually may refer to a magnetic or magnetizable objects storage site. As an example as shown in FIG. 1, a first type of magnetic or magnetizable objects may be stored in a first magnetic or magnetizable objects storage site 210. A second, different type of magnetic or magnetizable objects may be stored in a second magnetic or magnetizable objects storage site 220. The first type of magnetic or magnetizable objects is suitable to bind to one of the binding sites of the sensor surface, in this particular embodiment the binding site 201. The second type of magnetic or magnetizable objects may be suitable to bind to another of the binding sites of the sensor surface, in this particular embodiment the binding site 202. Each of the binding sites, e.g. 201 and 202, may be provided with a dedicated magnetic or magnetizable objects storage site, e.g. 210 respectively 220. Similarly, all the other binding sites 121 may be provided with one dedicated magnetic or magnetizable objects storage site comprising magnetic or magnetizable objects suitable to co-operate with this specific binding site.

The magnetic or magnetizable objects provided to bind to a first of the binding sites, may be different from the magnetic or magnetizable objects provided to bind to another of the binding sites. For each of the binding sites, magnetic or magnetizable objects of a particular kind may be provided at a dedicated position, i.e. a magnetic or magnetizable objects storage site, with which the particular binding site is to co-operate.

The magnetic field generating means generating a magnetic field, moves the magnetic or magnetizable objects from the dedicated magnetic or magnetizable objects storage site along the binding site to which it is intended to bind, i.e. over the co-operating binding site. By providing different types of magnetic or magnetizable objects, e.g. different beads, in a position adjacent to the intended binding site, cross-reactivity issues may be reduced, or even avoided.

The term “storage” means that the magnetic or magnetizable objects are located and/or stored at this location or site prior to the application of the magnetic field by means of the magnetic field generating means.

The magnetic sensor device 20 may comprise at least one detector 30 for providing a detection signal 60 representative of the presence and/or amount of labelled target moieties bound to the binding sites 121 of the sensor surface 120. The detector 30 may be an integral part of the sensor device 30 or the sensor device may be adapted for use with a separate detector, e.g. by being provided with a suitable window.

Detection of the presence of magnetic or magnetizable objects on the sensor surface 120, more particular on the binding sites 121 of the sensor surface 120, can be done in various ways, e.g. magnetically (e.g. magnetic sensors based on AMR (anisotropic magneto resistance), GMR (giant magneto resistance) and TMR (tunnel magneto resistance) elements or on Hall sensors), optically (reflection, absorption, scattering, fluorescence, chemiluminescence, RAMAN scattering, etc.), acoustically (QCM, SAW, BAW, etc.), or electrically (impedance measurement, conductance measurement, electrochemically, redox recycling, etc.). The detectors 30 may be integrated into the magnetic sensor device 20 as a disposable part (e.g. a magnetoresisitve sensor) or may be separated from the magnetic sensor device 20, optionally as a disposable part (e.g. optical unit).

The detector or the detectors may be adapted to provide a detection signal representative for the presence and/or amount of magnetic or magnetizable objects on each of the binding sites individually, or may be adapted to provide a detection signal representative for the presence and/or amount of magnetic or magnetizable objects on all the binding sites as a whole.

The magnetic sensor device 20 may be part of a magnetic sensor chip, optionally a biochip. Such chip may e.g. be a plate such as a titerplate.

In accordance with methods of the present invention, target moieties are to be detected in a sample fluid, which can be the original sample or can already have been processed before insertion into the sensor device 20 (e.g. diluted, digested, degraded, biochemically modified, filtered, dissolved into a buffer, etc). The original fluids can be, for example, biological fluids such as saliva, sputum, blood, blood plasma, cells, interstitial fluid or urine, or other fluids such as drinking fluids, environmental fluids, or a fluid that results from sample pre-treatment. The fluid 27 can, for example, comprise elements of solid sample material, e.g. from biopsies, stool, food, feed, environmental samples.

Using a magnetic sensor device 20 as shown in FIG. 1, a method for determining the presence and/or amount of target moieties 22 in a sample fluid 27 by means of a sandwich assay will be explained. FIG. 2A to FIG. 2C show longitudinal cross-sections of the magnetic sensor device 20 of FIG. 1, at different moments in time during the assay.

A magnetic sensor device 20 comprising a sensor channel 12 having a sensor surface 120. For each binding site 121, at a first position 123, non-bound magnetic or magnetizable objects 23 are provided, e.g. in dry state.

As shown in FIG. 2A, a sample fluid 27 with target moieties 22 is provided to the sensor channel 12.

The target moieties 22 are allowed to bind with the magnetic or magnetizable objects 23 for providing labelled target moieties 25.

As shown in FIG. 2B, by means of the magnetic field generating means 26 e.g. an elecromagnet 46 activated or deactivated by the control unit comprising an actuator 47, a magnetic field is applied, the magnetic field having an in-plane field component for inducing a movement of the magnetic or magnetizable objects 23 along one of the binding sites 121 of the sensor surface 120. The magnetic or magnetizable objects 23, either bound to target moieties 22 or not, move, e.g. roll or slide, over the binding sites 121 of the sensor surface 120, allowing the labelled target moieties 25 to bind to target probes 28 on the binding sites 121 of the sensor surface 120 of the magnetic sensor device 20. The magnetic or magnetizable objects 23 not bound to target moiety 22 move towards, even to a central point 200 under influence of the applied magnetic field.

As such, substantially only magnetic or magnetizable objects 23 being part of a labelled target moiety 25 remain present at the sensor surface 120. Optionally the magnetic field generating means 26 may be deactivated.

As shown in FIG. 2C, by means of at least one detector 30 at the sensor surface 120, a detection signal 60 may be obtained. The detection signal 60 may be measured, and the measured detection signal may be used to determine the presence and/or amount of labelled target moieties 25 bound to the binding sites 121 of the sensor surface 120.

As an alternative, the magnetic sensor device 20 comprises a sensor channel 12 having a sensor surface 120 and an opposite wall, opposite to the sensor surface, optionally an upper wall. For each binding site 121, at a first position being located on the opposite wall, non-bound magnetic or magnetizable objects 23 are provided, e.g. in dry state.

Another example of an assay is schematically shown in FIG. 3. The assay shown is a so-called competitive assay. The stage the assay is in, is the stage where the magnetic field generating means 26 generates an electrical field to move the magnetic or magnetizable objects 23, either bound to target moiety 22 or not, towards the central point 200, more particularly from a first position 123 towards even to the central point 200.

Target probes 28 are provided on binding sites 121 of the sensor surface 120 of an alternative magnetic sensor device 21, the same references refer to identical or similar elements. Magnetic or magnetizable objects 23 are present at first positions 123 in the sensor channel 12. By providing sample fluid 27 comprising target moieties 22 in the sensor channel, the target moieties 22 bind to some of the magnetic or magnetizable objects 23, providing labelled target moieties 25. The amount of magnetic or magnetizable objects 23 is chosen such that all target moieties 22 may bind to one of the magnetic or magnetizable objects 23. Other magnetic or magnetizable objects 23 remain unbound to target moieties. Target probes 28 are provided at the binding sites of the sensor surface 120, the target probes 28 comprising the same or a similar type of moiety 29, which compete with the target moieties 22 in the sample fluid 27 for binding to the magnetic or magnetizable objects 23.

When a magnetic field generating means 26 provides a magnetic field inducing a movement of magnetic or magnetizable objects 23 along sensor surface 120, the magnetic or magnetizable objects 23 bound to target moieties 22 or not, will move along the binding sites 121 of the sensor surface 120.

The magnetic or magnetizable objects 23 not bound to a target moiety 22 will pass along the moieties 29 present on the binding sites, i.e. the target probes 28. The magnetic or magnetizable objects 23 not bound to a target moiety 22 will bind to the moieties 29 and remain at a binding site 121 of the sensor surface 120.

Magnetic or magnetizable objects 23 that form a part of labelled target moieties 25 will pass the binding site 121 of the sensor surface 120 under the magnetic field applied, and will be moved towards, even to the central point 200, since the binding places for the target moieties 22 and moieties 29 are already occupied by some other target moieties 22. The magnetic or magnetizable objects 23 that form part of the labelled target moieties 25 are brought to the central point 200, whereas the magnetic or magnetizable objects 23 not bound to a target moiety 22 remain bound to the moieties 29 and remain at a binding site 121 of the sensor surface 120. As such, the magnetic or magnetizable object 23 that form part of the labelled target moieties 25 and the magnetic or magnetizable objects 23 not bound to a target moiety 22 are separated.

A magnetic field generating means is provided, e.g. a permanent magnet 48, for providing motion to the magnetic or magnetisable objects 23.

Other arrangements for accomplishing the objectives of the magnetic sensor device embodying the invention will be obvious for those skilled in the art.

For example, detection of the magnetic particles 23 may be done by means of magnetic methods (e.g. magnetoresistive sensor elements, hall sensors, coils), optical methods (e.g. imaging fluorescence, chemiluminescence, absorption, scattering, surface plasmon resonance, Raman, frustrated total internal reflection, . . . ), sonic detection (e.g. surface acoustic wave, bulk acoustic wave, cantilever, quartz crystal, . . . ), electrical detection (e.g. conduction, impedance, amperometric, redox cycling).

The above-described method embodiments of the present invention may be implemented in a processing system 500 such as shown in FIG. 4 and FIG. 5. FIG. 4 and FIG. 5 show a configuration of processing system 500 that includes at least one programmable processor 503 coupled to a memory subsystem 505 that includes at least one form of memory, e.g., RAM, ROM, and so forth. It is to be noted that the processor 503 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. The processing system may include a storage subsystem 507 that has at least one disk drive and/or CD-ROM drive and/or DVD drive. In some implementations, a display system, a keyboard, and a pointing device may be included as part of a user interface subsystem 509 to provide for a user to manually input information. Ports for inputting and outputting data also may be included. More elements such as network connections, interfaces to various devices, and so forth, may be included, but are not illustrated in FIG. 4 and FIG. 5. The various elements of the processing system 500 may be coupled in various ways, including via a bus subsystem 513 shown in FIG. 4 for simplicity as a single bus, but will be understood to those in the art to include a system of at least one bus. The memory of the memory subsystem 505 may at some time hold part or all (in either case shown as 511) of a set of instructions that when executed on the processing system 500 implement the steps of the method embodiments described herein. Thus, while a processing system 500 such as shown in FIG. 4 and FIG. 5 is prior art, a system that includes the instructions to implement aspects of the methods for determining the presence and/or amount of target moieties in a sample fluid, is not prior art, and therefore FIG. 4 and FIG. 5 is not labelled as prior art.

A control unit 520 comprising the processing system 500 may drive, e.g. activate and/or deactivate, the activatable magnetic field generating means 26 by means of the one or more actuators 47. A control unit 520 may obtain a detection signal for determining the presence and/or amount of magnetic or magnetizable objects bound to the binding sites of the sensor surface 120 from the detectors 30. The control unit for driving the magnetic field generating means 26 and the control unit for obtaining the one or more detection signals may be one and the same control unit. In alternative embodiments, separate control units may be provided. In case of embodiments with a permanent magnet as magnetic field generating means 26, only a control unit for obtaining a detection signal may be provided.

The control unit 520 or control units may be adapted to synchronise the one or more actuators 47 and the one or more detectors 30.

The processing system 500 may be integrated in the control unit 520 (FIG. 4), which control unit 520 is adapted to control the actuators 47 and/or to obtain a detection signal from at least one detector 30, optionally using a data capturing unit for capturing the data. The processing system 500 may provide the settings for obtaining data (obtaining the measurement signal 60) and/or for activating the actuators 47. The control unit 520 may provide control signals to the actuators 47 and/or the at least one detector 30, based on settings as provided by the processing system 500. The control unit 520 may provide the processing system 500 with detection signals from the at least one detector 30 for determining from these measured detection signals the presence and/or amount of magnetic or magnetizable objects 23 bound to the binding sites of the sensor surface 120.

As an alternative, shown in FIG. 5, the processing system 500 may be a separate element of the control unit 520. The control unit 520 may comprise a converting unit 530 to provide control signals to the actuators 47 and/or the at least one detector 30 based on settings as provided by the processing system 500.

The processing system 500 may run a computer program product for executing a method for determining the presence and/or amount of target moieties in a sample fluid according to the present invention. The computer program product is suitable and adapted to generate the settings for the various components of the magnetic sensor device 20, 21, such as the timing and setting for the activation of the magnetic field generating means 26 by means of the actuator or actuators 47, the timing and setting for obtaining a detection signal 60 from the binding sites 121 of the sensor surface 120 by means of at least one detector 30 and alike. The computer program product is suitable and adapted to determine the presence and/or amount of magnetic or magnetizable objects 23 bound to the binding sites 121 based on the measured detection signal 60.

The present invention also includes a computer program product, which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

It is to be understood that although preferred embodiments, specific constructions and configurations, as well as materials, have been discussed herein for devices according to the present invention, various changes or modifications in form and detail may be made without departing from the scope of this invention as defined by the appended claims.

1. A magnetic sensor device (20, 21) for determining the presence and/or amount of target moieties (22) in a sample fluid (27), the magnetic sensor device comprising:
a sensor chamber (12) having a sensor surface (120), the sensor surface comprising a plurality of binding sites (121) adapted for binding magnetic or magnetizable objects (23);
a magnetic field generating means (26) adapted for generating a magnetic field for inducing a movement of magnetic or magnetizable objects (23) along the sensor surface (120), the magnetic field having a magnetic field gradient across the sensor surface (120);
wherein the magnetic field gradient generated by said magnetic field generating means in each of the centres (122) of the plurality of binding sites is substantially identical.

2. Magnetic sensor device (20, 21) according to claim 1, wherein the strongest magnetic field generated by magnetic field generating means (26) occurs at a central point (200) of the sensor surface (120), the centres (122) of the plurality of binding sites (121) being symmetrically distributed with regard to said central point, wherein said magnetic field generating means (26) is adapted for generating a magnetic field for moving magnetic or magnetizable objects (23) not bound to the binding sites (121) towards the central point (200).

3. A magnetic sensor device (20, 21) according to claim 1, wherein the magnetic sensor device comprises a sensor substrate providing said sensor surface, the magnetic field generating means (26) being integrated in the sensor substrate wherein the magnetic field generating means (26) is moveable relative to the sensor surface, and wherein said magnetic sensor device further comprises at least one detector (30) for providing a detection signal (60) representative for the presence and/or amount of magnetic or magnetizable objects (23) bound to said binding sites (121).

4. A magnetic sensor device (20, 21) according to claim 1, wherein the sensor chamber (12) comprises a plurality of magnetic or magnetizable objects storage sites (210, 220) for storing magnetic or magnetizable objects (23), the magnetic field generating means (26) being adapted for generating a magnetic field for inducing a movement of magnetic or magnetizable objects (23) from one of the magnetic or magnetizable objects storage sites (210, 220) along one of the binding sites (201, 202) of the sensor surface (120).

5. A magnetic sensor device (20, 21) according claim 4, wherein for each of the binding sites (201, 202), the sensor chamber (12) is provided with one dedicated magnetic or magnetizable objects storage site (210, 220) for storing magnetic or magnetizable objects (23) for co-operating with said binding site (201, 202), the magnetic field generating means (26) being adapted for generating a magnetic field for inducing a movement of the magnetic or magnetizable objects (23) from the dedicated magnetic or magnetizable objects storage sites along said binding site.

6. Use of the magnetic sensor device (20, 21) according to claim 1 in molecular diagnostics, biological sample analysis or chemical sample analysis.

7. A magnetic sensor chip comprising at least one magnetic sensor device (20, 21) according to claim 1.

8. A magnetic sensor chip according to claim 7, wherein the magnetic sensor chip is a biochip.

9. A method for determining the presence and/or amount of target moieties (22) in a sample fluid (27), the method being for use with a sensor surface having a plurality of binding sites (121) adapted for binding magnetic or magnetizable objects (23), each binding site having a centre (122), the method comprising:
allowing target moieties (22) in a sample fluid (27) to bind with magnetic or magnetizable objects (23), thus providing labelled target moieties (25);
applying a magnetic field for inducing a movement of the magnetic or magnetizable objects (23) along the binding sites, thus allowing magnetic or magnetizable objects (23) to bind to said binding sites (121) and moving magnetic or magnetizable objects not bound to a binding site (121) to a position past the binding site, the magnetic field gradient generated in each of the centres (122) of the plurality of binding sites being substantially identical;
obtaining a detection signal (60) representative of presence of magnetic or magnetizable objects (23) bound to the one or more of the binding sites (121), and
determining the presence and/or amount of target moieties (22) in the sample fluid based upon the detected signal.

10. A method according to claim 9, the magnetic field having an amplitude, wherein the amplitude of the magnetic field is variable in time.

11. A method according to claim 9, wherein allowing target moieties (22) in the sample fluid (27) to bind with magnetic or magnetizable objects (23) comprises providing a sample fluid (27) with target moieties (22) and providing magnetic or magnetisable objects (23) to the sample fluid.

12. Use of the method according to claim 9 in molecular diagnostics, biological sample analysis or chemical sample analysis.

13. A computer program product for performing, when executed on a processing system (500), a method as in claim 9.

14. A machine readable data storage device for storing the computer program product of claim 13.

15. A controller for use in a method for determining the presence and/or amount of target moieties (22) in a sample fluid (27) and with a sensor surface having a plurality of binding sites (121) adapted for binding magnetic or magnetizable objects (23), each binding site having a centre (122), the controller comprising:
means for controlling target moieties (22) to bind in a sample fluid (27) to bind with magnetic or magnetizable objects (23), thus providing labelled target moieties (25);
means for controlling the application of a magnetic field for inducing a movement of the magnetic or magnetizable objects (23) along the binding sites, thus allowing magnetic or magnetizable objects (23) to bind to said binding sites (121) and moving magnetic or magnetizable objects not bound to a binding site (121) to a position past the binding sites, the magnetic field gradient generated in each of the centres (122) of the plurality of binding sites being substantially identical;
means for controlling generation of a detection signal (60) representative of presence of magnetic or magnetizable objects (23) bound to the one or more of the binding sites (121), and for determining the presence and/or amount of target moieties (22) in the sample fluid based upon the detected signal.
